(19) United States
(12) Patent Application Publication
(10) Pub. No.: US 2019/0031003 A1
(43) Pub. Date: Jan. 31, 2019

(54) FORWARD TILTING PROTECTIVE CANOPY TOP FOR THREE-WHEELED VEHICLES AND AUTOCYCLES

(71) Applicant: Patrick Wade Bennett, Gainesville, GA (US)

(72) Inventor: Patrick Wade Bennett, Gainesville, GA (US)

(73) Assignee: Patrick Wade Bennett

(21) Appl. No.: 15/660,831

(22) Filed: Jul. 26, 2017

(51) Int. Cl. B60J 7/10; B60J 7/12

(52) U.S. Cl. CPC B60J 7/104; B60J 7/123

(57) ABSTRACT

A forward tilting removable canopy top for a three-wheeled vehicle and or autocycle that are open to the elements. The canopy comprises a ridged structure covered by fabrics of various types or by ridged hard material. The removable canopy top is supported by two detachable front A-arm mounting brackets and one rear support bracket. Rear support bracket encompasses a securing latch when released allows the canopy to tilt forward via quick release pivot points for rotation about a first, fixed axis located on each front A-arm mounting bracket. Canopy top can be removed at fixed location points atop same afore mentioned A-arm mounting brackets via quick release bolts and or knob. Forward tilting of the canopy top around fixed A-arm mounting points allows easy entry and exit for vehicle occupants while providing protections from the elements. Canopy top is designed to be stored off vehicle when not in use.

### FIELD OF INVENTION

This invention relates to the field of tops or removable tops for three wheeled vehicles and autocycles.

### BACKGROUND OF INVENTION

Three wheeled vehicles and autocycles of various design that have an open cabin or cockpit are popular with consumers because of their closeness and driving characteristics to a motorcycle but with greater stability and comfort. Some of these vehicles are sold without any type of protection from the environment. These vehicles are open to the sun, and rain and cannot be enjoyed fully. Various solutions to this problem have been developed but do not offer the occupants the full use of the vehicle as originally designed. These noted covers are bulky, and do not allow removal after installation. They require extensive structural additions to vehicles and cause problems for entry and exiting. With this and other ideas in mind the present invention was developed. In it a removable canopy top is provided that can be easily tilted out of the way for entry and exiting. Can be quickly removed and stored off vehicle to allow a full open cockpit. Additionally, the basic design allows the full removal of the inventions front mounting A-arms from vehicle with minimal effort. This allows the vehicle to be returned to its original configuration and appearance.

### SUMMARY OF THE INVENTION

According to one aspect of the presented invention a removable canopy top for a three wheeled, autocycle vehicle having no top or canopy. The removable canopy top comprises a ridged canopy frame with covering that can be selectively secured to the vehicle to cover the seating area.

According to another aspect of the invention related to the function of the canopy top is the ability to remove the canopy completely from the vehicle allowing the use of the vehicle without a cover. This is accomplished by a quick disconnect system at the pivot points located atop front A-arm mounting brackets. This disconnect system may comprise of a bolt, screws, knobs, or a pull pin to allow the canopy top to be disconnected from the front A-arm mounting brackets.

Other aspects of the design are the ability to further remove or disconnect the front A-arm mounting brackets from the vehicle. Allowing full return of vehicle to the original operational design and visual appearance.

Other aspects of the invention related to the removable canopy top may comprise a flexible fabric member that can be removed and replaced as needed. The ridged canopy frame may also be covered with a flexible mesh fabric to allow partial shading of the seating area for partial open-air driving when installed. The ridged canopy frame may also be covered with a solid material for a more durable covering.

Other aspects of the invention related to the ridged canopy top is the ability to tilt forward away from the seating area allowing easier entry and exiting of vehicle. In one aspect, the top is lowered to cover occupants. When unlatched the cover rises from the rear tilting forward via pivot points attached to front mounting brackets. Canopy cover tilts completely way from seating.

Other aspect of the invention related to the ridged canopy top is the ability to adjust the height of the top canopy to accommodate occupants and operators of various height.

### BRIEF DESCRIPTION OF DRAWINGS

FIG. 1 is a rear perspective view of an exemplary three wheeled vehicle and or autocycle incorporating the teachings of the preferred embodiment of the present invention, shown with tilting removable canopy top in lowered and latched position.

FIG. 2 is a rear perspective view of an exemplary three wheeled vehicle and or autocycle incorporating the teachings of the preferred embodiment of the present invention, shown with tilting removable canopy top tilted forward and in the unlatched position.

FIG. 3 is a view of an exemplary three wheeled vehicle and or autocycle incorporating the teachings of the preferred embodiment of the present invention, shown with tilting removable canopy top in lowered and latched position.

FIG. 4 is a front view of an exemplary three wheeled vehicle and or autocycle incorporating the teachings of the preferred embodiment of the present invention, shown with tilting removable canopy top tilted forward in the unlatched position.

FIG. 5 is a perspective view of preferred embodiment of tilting canopy top frame with mounting hardware.

FIG. 6 is a perspective view showing a ridged covering positioned over tilting canopy top frame with mounting hardware.

FIG. 7 is a perspective view showing a flexible covering positioned over tilting canopy top frame with mounting hardware.

FIG. 8 is a fragmented perspective view of preferred embodiment of fasteners used to attach flexible or ridged cover to tilting canopy top frame.

FIG. 9-13 illustrate alternative embodiments of fasteners used to attach the flexible fabric or ridged covering to tilting canopy top frame.

FIG. 14 is a fragmented rear perspective view showing the attachment of the frame hoop tilt bracket to A-arm pivot bracket.

FIG. 15 is a fragmented side view showing the attachment of removable tilting canopy top frame to A-arm pivot bracket by means of A-arm pivot mount bolt/knob.

FIG. 16 is a fragmented perspective view illustrating preferred embodiment of attaching mounting A-arm and removable front A-arm mounting bracket to exemplary three wheeled vehicle and or autocycle via vehicle mirror mounting point.

FIG. 17 is a fragmented perspective view illustrating preferred embodiment of attaching mounting A-arm and removable front A-arm mounting bracket to exemplary three wheeled vehicle and or autocycle via vehicle mirror mounting point. Illustration further explains how mounting A-arm is removed from front A-arm mounting bracket and vehicle with removal of A-arm mount quick disconnect bolt.

FIG. 18 is a fragmented side view illustrating preferred embodiment of attaching mounting A-arm and removable front A-arm mounting bracket to exemplary three wheeled vehicle and or autocycle via vehicle mirror mounting point.

FIG. 19-20 is a fragmented side view illustrating preferred embodiment of attaching mounting A-arm and removable front A-arm mounting bracket to exemplary three wheeled vehicle and or autocycle via vehicle mirror mounting point. Illustration further explains how mounting A-arm is removed from front A-arm mounting bracket and vehicle with removal of A-arm mount quick disconnect bolt.

FIG. 21-22 illustrate alternative embodiments of attaching mounting A-arm and removable front A-arm mounting bracket. Illustration further explains how mounting A-arm is removed from front A-arm mounting bracket and vehicle with removal of A-arm mount quick disconnect bolt.

FIG. 23 is a fragmented rear perspective view showing attachment of latch frame bracket to tilting canopy top frame by means of frame hoop mounting brackets. Illustration includes attachment of latch to latch frame bracket.

FIG. 24 is a fragmented rear perspective view showing engagement of latch, latch frame bracket and tilting canopy top frame to roll bar mounting bracket. Latch locks to stricker bolt attached to roll bar mounting bracket.

FIG. 25 is a front perspective view illustrating the preferred embodiment of roll bar mounting bracket. Drawing includes mounting hardware and stricker bolt.

FIG. 26 is a front perspective view illustrating how roll bar mounting bracket of FIG. 25 is attached to exemplary three wheeled vehicle and or autocycle roll over protection bars.

FIG. 27 is a side perspective view of an exemplary three wheeled vehicle and or autocycle incorporating the teachings of the preferred embodiment of the present invention, shown with removable canopy top in lowered and latched position.

FIG. 28 is a side perspective view of an exemplary three wheeled vehicle and or autocycle showing the preferred embodiment of the present invention, shown with removable canopy top unlatched and raised in the entry exit position.

FIG. 29 is a side perspective view of an exemplary three wheeled vehicle and or autocycle illustrating the preferred embodiment of the present invention, shown with removable canopy top unlatched and removed from vehicle by means of removing A-arm pivot mounting bolt and or knobs.

### DETAILED DESCRIPTION OF THE INVENTION

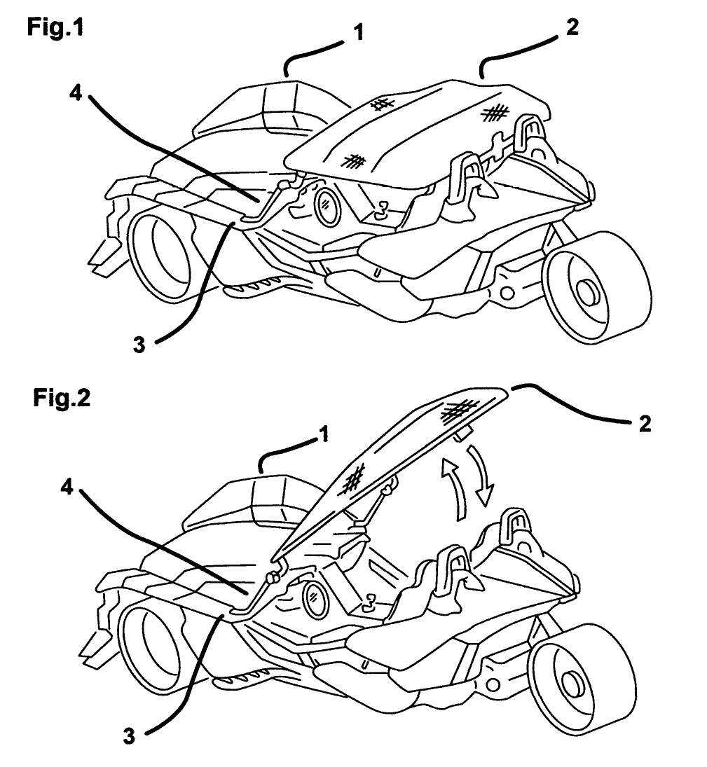

As shown in FIG. 1 the present invention is directed to a tilted forward canopy top 2 for a three-wheeler vehicle or autocycle 1. The rear perspective shows lowered canopy top 1 attached to front mounting A-arm 4 that is attached to vehicle 1 by means of front A-arm mounting brackets 3.

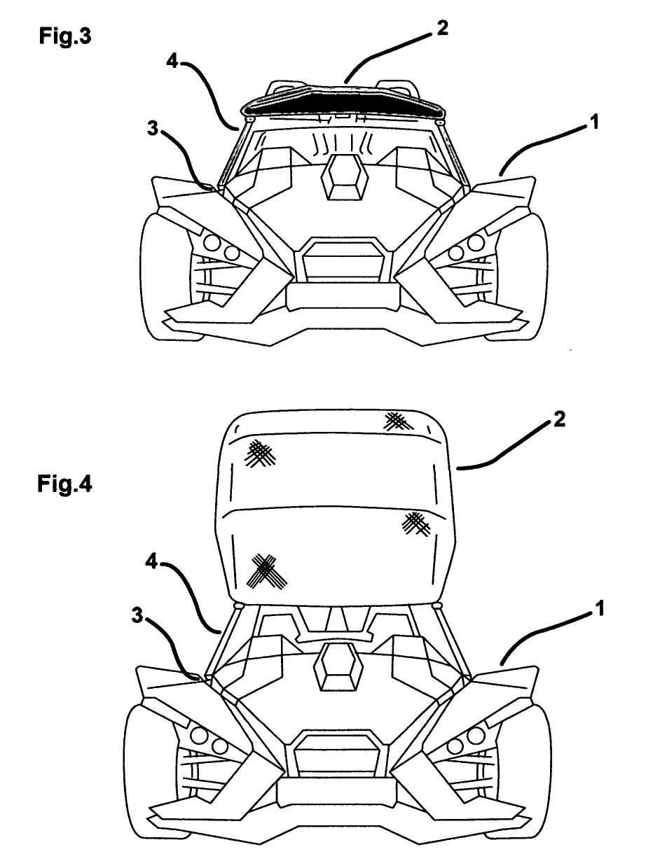

FIG. 2 shows presented canopy top 2 in raised position allowed by rotational pivot point attached to front mounting A-arm 4 mounted to vehicle 1 via front A-arm mounting bracket 3. Movement of canopy top is also embodied in FIG. 3-4 showing the canopy top closed and latched to three-wheeled vehicle or autocycle 1 (FIG. 3) where (FIG. 4) shows Canopy top unlatched and opened for entry and or exiting of three-wheeled vehicle or autocycle.

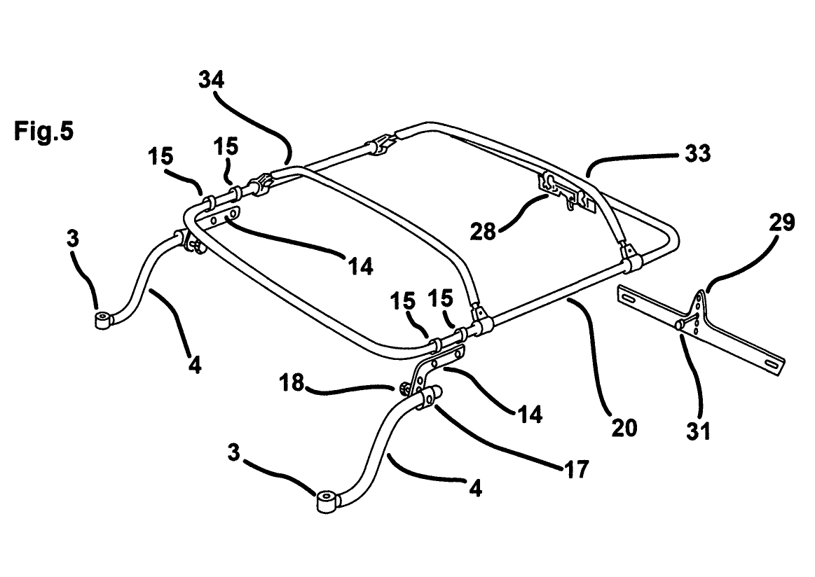

Canopy top frame and required mounting brackets are best represented in front perspective FIG. 5 showing the attachment locations of front A-arm mounting brackets 3 to front mounting A-arms 4. Front mounting A-arm is connected to canopy frame 20 by A-arm pivot mount 17 and A-arm pivot mount bolt 18 by means of frame hoop tilt bracket 14. Frame hoop tilt bracket is secured to canopy frame 20 using frame hoop mounting bracket 15. FIG. 5 shows rear bow 33 and front bow 34 attached to canopy frame 20 and latch mounting bracket 28. Roll bar mounting bracket 29 is also presented in correct orientation to front perspective view of canopy frame 20 and includes stricker bolt 31 bolted to roll bar mounting bracket 29.

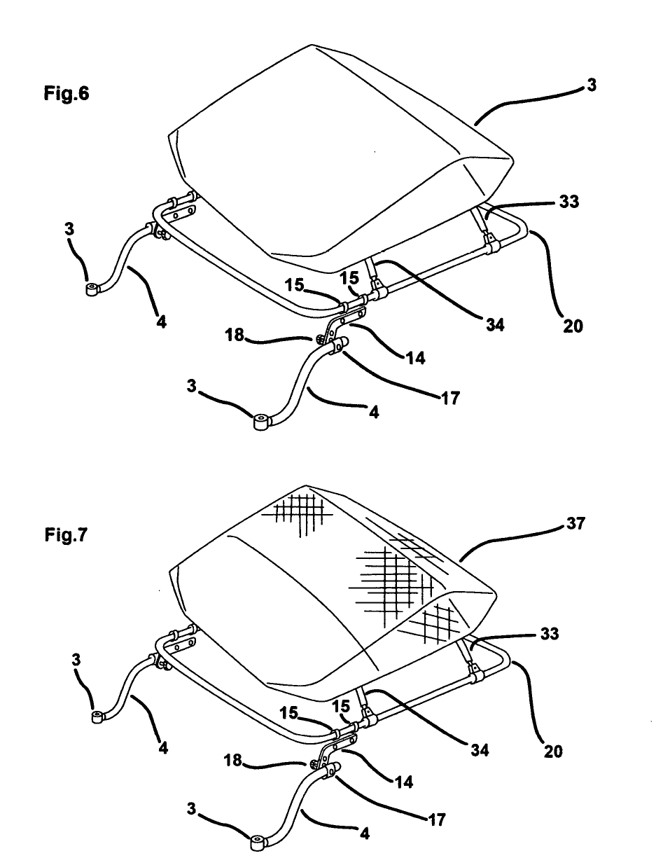

FIG. 6 present invention of tilt forward canopy top 2 with one possible version of ridged cover 36 positioned over canopy frame hoop 20 that shows positioning of required mounting hardware. FIG. 6 includes mounting positions of front A-arm mounting bracket 3, front mounting arm 4, frame hoop tilt bracket 14, frame hoop mounting bracket 15, A-arm pivot mount 17, A-arm pivot mounting bolt 18, Frame hoop 20, rear bow 33 and front bow 34.

FIG. 7 present invention of tilt forward canopy top 2 with one possible version of flexible fabric cover 37 positioned over canopy frame hoop 20 that shows positioning of required mounting hardware. FIG. 7 includes mounting positions of front A-arm mounting bracket 3, front mounting arm 4, frame hoop tilt bracket 14, frame hoop mounting bracket 15, A-arm pivot mount 17, A-arm pivot mounting bolt 18, Frame hoop 20, rear bow 33 and front bow 34.

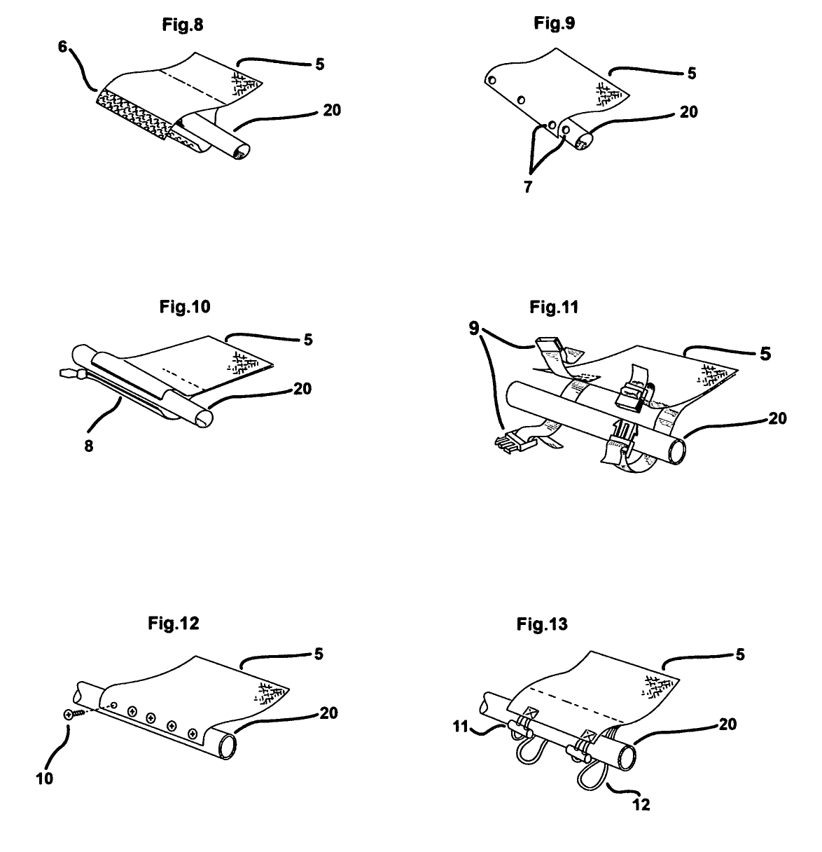

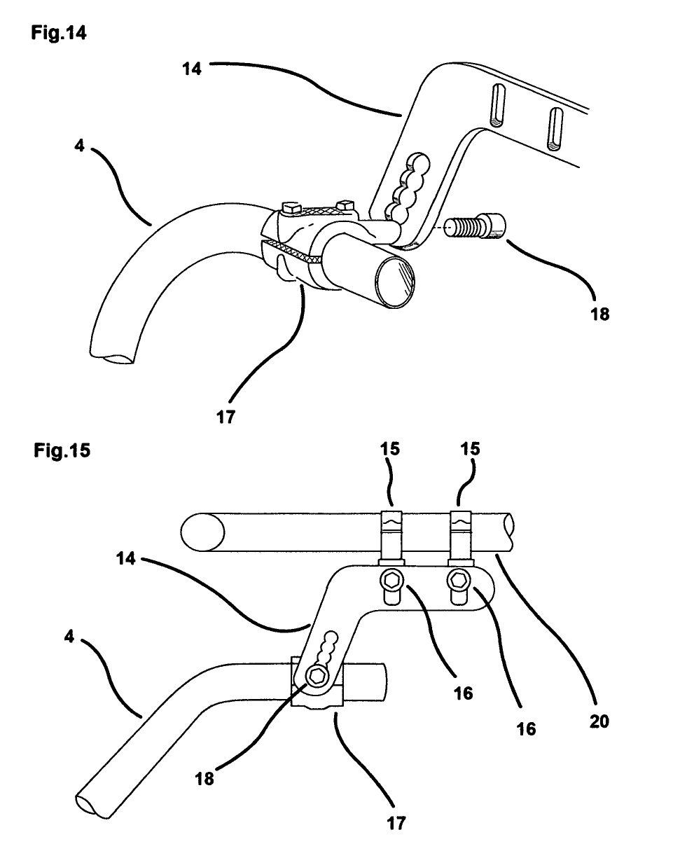

FIGS. 8-13 show various possible attachment possibilities of either ridged cover 36 or flexibly fabric 37 to Frame hoop 20, rear bow 33, and front bow 34. The preferred attachment method shown in FIG. 8 illustrates present use of loop and hook fastener attachment to frame hoop 20. FIG. 9 shows snap fasteners 7 for securing cover to frame hoop 20. FIG. 10 illustrates the use of a zipper fastener 8 to secure flexible fabric cover 37 to frame hoop 20. FIG. 11 shows the use of buckle and strap fasteners 9 to secure flexible fabric cover 37 to frame hoop 20. FIG. 12 illustrates the use of screws to fasten either the ridged cover 36 or flexible fabric cover 37 to frame hoop 20. One further attachment embodiment can be seen in FIG. 13 using toggle button fasteners 11 and shock cord looped fasteners 12.

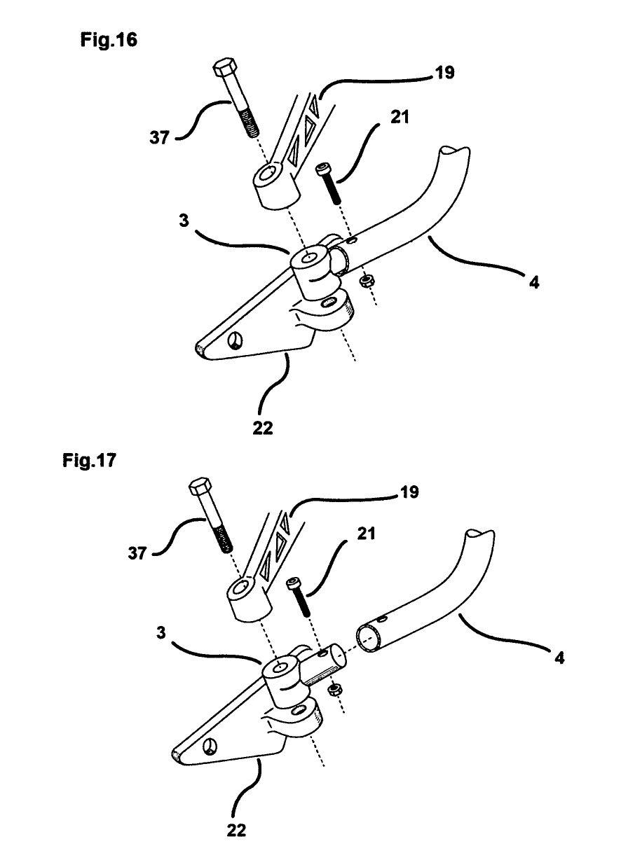

In the embodiment shown in FIG. 14 the frame tilt bracket is shown attached to A-arm pivot mount 17 by use of A-arm pivot mount bolt 18. The A-arm pivot bolt 18 may also be embodied by a pivot knob. A-arm pivot mount 17 is secured to mounting A-arm 4. Mounting A-arm 4 is further shown attached to the three-wheeled vehicle or autocycle by means of front A-arm mounting bracket 3 in FIG. 16

As shown in FIG. 15 the frame hoop 20 is attached to the frame tilt bracket by mean of frame hoop mounting bracket 15 and secured in place by use of frame hoop tilt bracket mounting bolts 16. FIG. 15 further illustrates how frame hoop tilt bracket 14 is secured to A-arm mount 4 with use of A-arm pivot mount 17 and A-arm pivot bolt or knob 18.

FIGS. 16-19 generally illustrates a method of attaching mounting A-arm 4 and front A-arm mounting bracket 3 to three-wheeled vehicle or autocycle. Front A-arm mounting bracket 3 is attached between vehicle mirror arm 19 and vehicle mirror mount 22 by means of front A-arm to vehicle mounting bolt 37.

FIG. 16 illustrated front perspective view of front A-arm mounting bracket 3 attached to mounting A-arm 4 by means of A-arm mount quick disconnect bolt 21. Front A-arm mounting bracket 3 is attached between the vehicle mirror mount 22 and vehicle mirror arm 19 and secured to three-wheeler vehicle or autocycle by front A-arm to vehicle mounting bolt 37.

FIG. 17 shows front perspective view of front A-arm mounting bracket 3 disconnected from mounting A-arm 4 by means of A-arm mount quick disconnect bolt 21. Disconnection of mounting A-arm 4 from front A-arm mounting bracket 3 allows for full removal of canopy top 2 shown in FIG. 1. Front A-arm mounting bracket 3 is attached between the vehicle mirror mount 22 and vehicle mirror arm 19 and secured to three-wheeler vehicle or autocycle by front A-arm to vehicle mounting bolt 37.

FIG. 18 shows side view of same illustration used for FIG. 16. This drawing shows front A-arm mounting bracket 3 connected to mounting A-arm 4 by means of A-arm mount quick disconnect bolt 21. Front A-arm mounting bracket 3 is attached between the vehicle mirror mount 22 and vehicle mirror arm 19 and secured to three-wheeler vehicle or autocycle by front A-arm to vehicle mounting bolt 37.

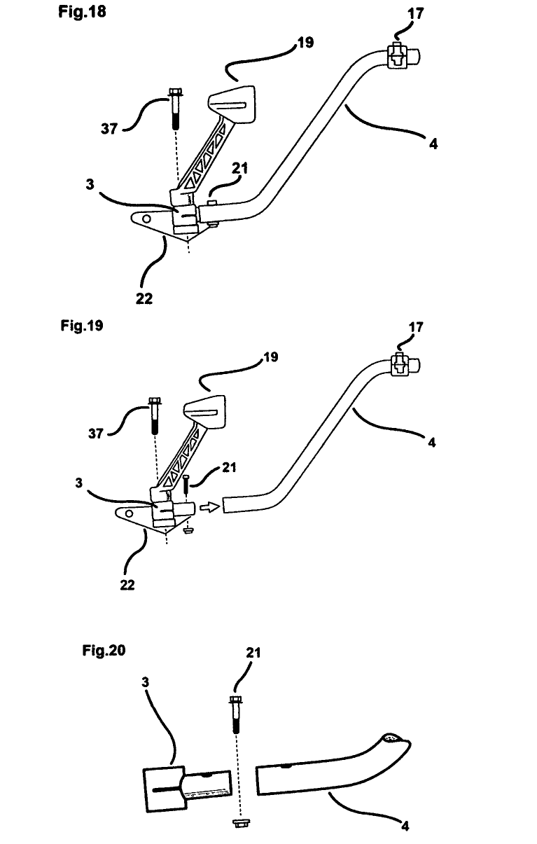

FIG. 19 shows side view of same illustration used for FIG. 17. FIG. 19 shows side view of front A-arm mounting bracket 3 disconnected from mounting A-arm 4 by means of A-arm mount quick disconnect bolt 21. Disconnection of mounting A-arm 4 from front A-arm mounting bracket 3 allows for full removal of canopy top 2 shown in FIG. 1. Front A-arm mounting bracket 3 is attached between the vehicle mirror mount 22 and vehicle mirror arm 19 and secured to three-wheeler vehicle or autocycle by front A-arm to vehicle mounting bolt 37.

A further explanation of the disconnection of front A-arm mounting bracket 3 from mounting A-arm 4 is illustrated in FIG. 20

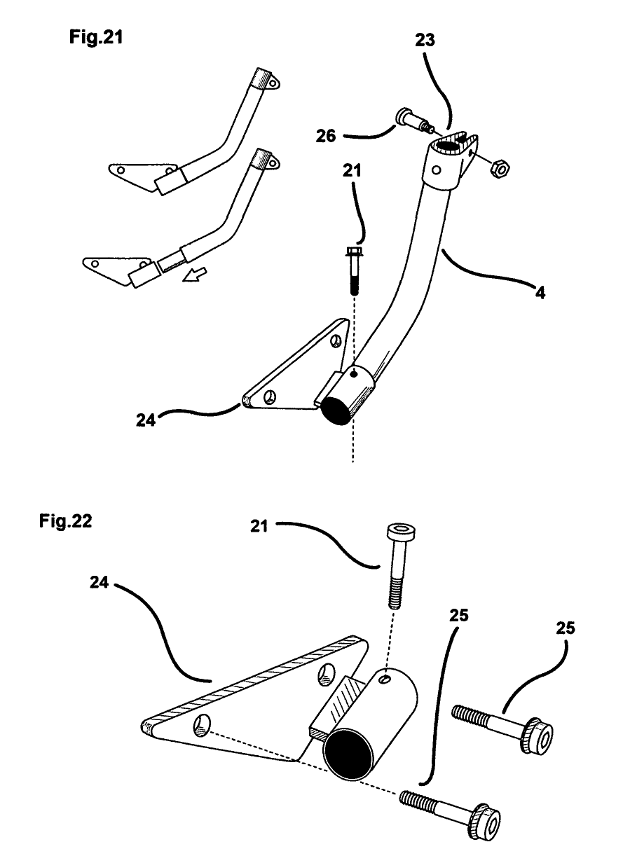

The attachment methods illustrated in FIGS. 14-20 are the preferred embodiment but are not the only design that can be utilized for allowing the tilting and removal of canopy cover 2. FIG. 21 shows alternative attachment method utilizing mounting A-arm 4 secured to front A-arm mirror bracket 24. Separation of mounting A-arm 4 from front A-arm mirror bracket 24 is accomplished by disconnection of A-arm mount quick disconnect bolt 21. Attachment of frame hoop tilt bracket is made to tilt bracket slide jaw 23 by means of slide jaw pivot bolt 26.

FIG. 22 shows details of attachment method of alternative front A-arm mirror mount bracket 24 to three-wheeled vehicle or autocycle 1 using mirror mount bracket bolts 25. A-arm mount quick disconnect bolt 21 is shown in correct mounting orientation to front perspective view of front A-arm mirror mount bracket 24.

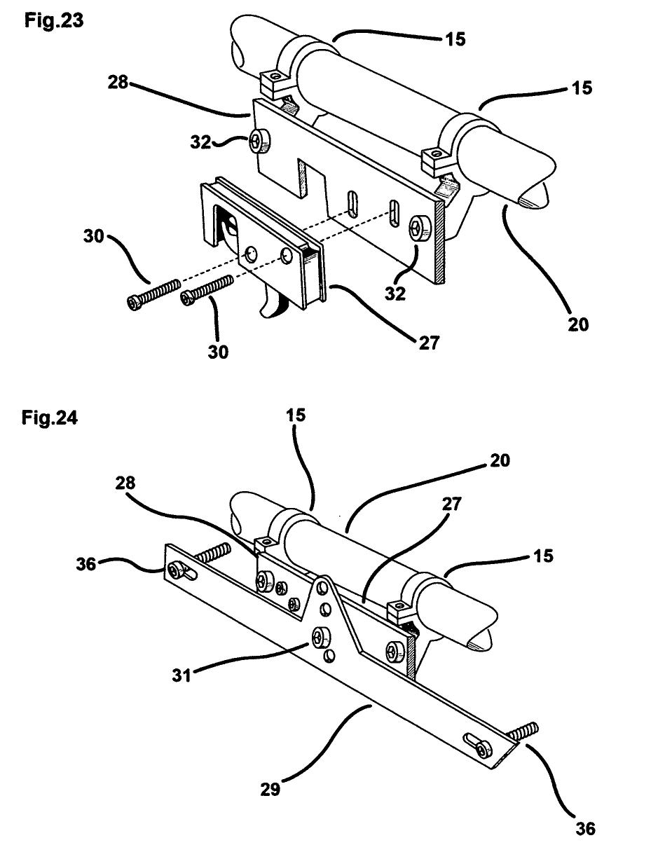

As Shown in rear perspective view FIG. 23 the latch frame bracket 28 is secured to the hoop frame 20 by means of frame hoop mount brackets 15 and latch frame mount bolts 32. Also shown in FIG. 23 is the attachment of latch 27 to latch frame bracket 28 utilizing latch mount bolts 30.

Securing of frame hoop 20 to roll bar mounting bracket 29 is accomplished using latch 27 described in FIG. 23. where latch assemble consisting of frame hoop mounting brackets 15, latch 27, latch frame bracket 28 lock to stricker bolt 31 affixed to roll bar mounting bracket 29 as illustrated in preferred embodiment of FIG. 24. Roll bar mounting bracket 29 is bolted to three-wheeled vehicle 1 via roll bar mounting bolts 36.

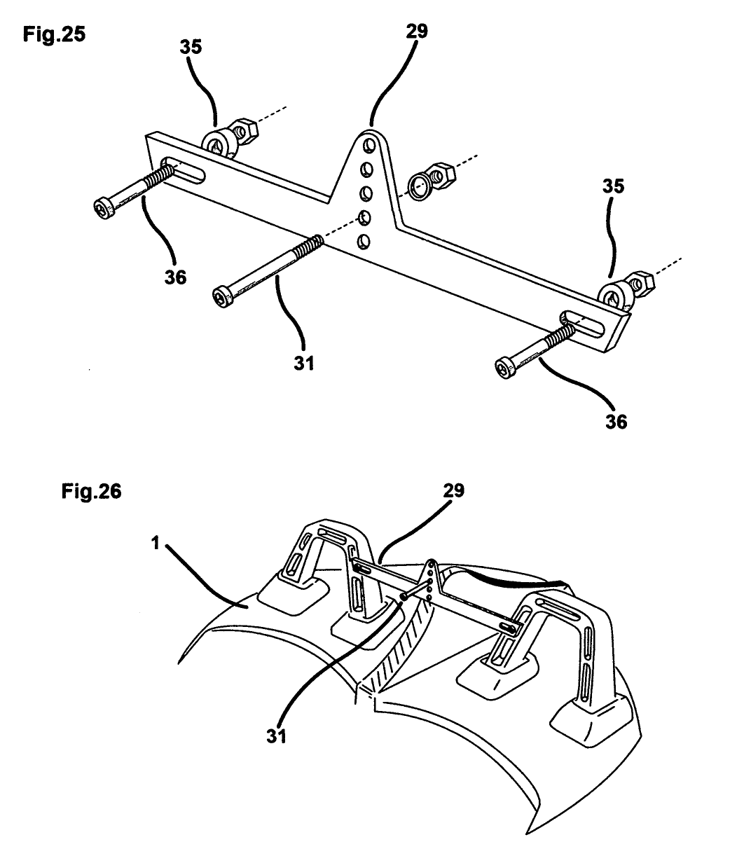

FIG. 25 illustrates the attachment hardware required to secure roll bar mounting bracket 29 to three-wheel vehicle and autocycles 1 shown in corresponding FIG. 26. Attachment hardware are roll bar mounting bracket spacer 35 used to stand bolt head off vehicle roll over hoop, roll bar mounting bolt 36 and stricker bolt 31.

FIG. 26 shows a fragmented front perspective view of three-wheeled vehicle and autocycle 1 with roll bar mounting bracket 29 with stricker bolt 31 secured to vehicle roll over hoops.

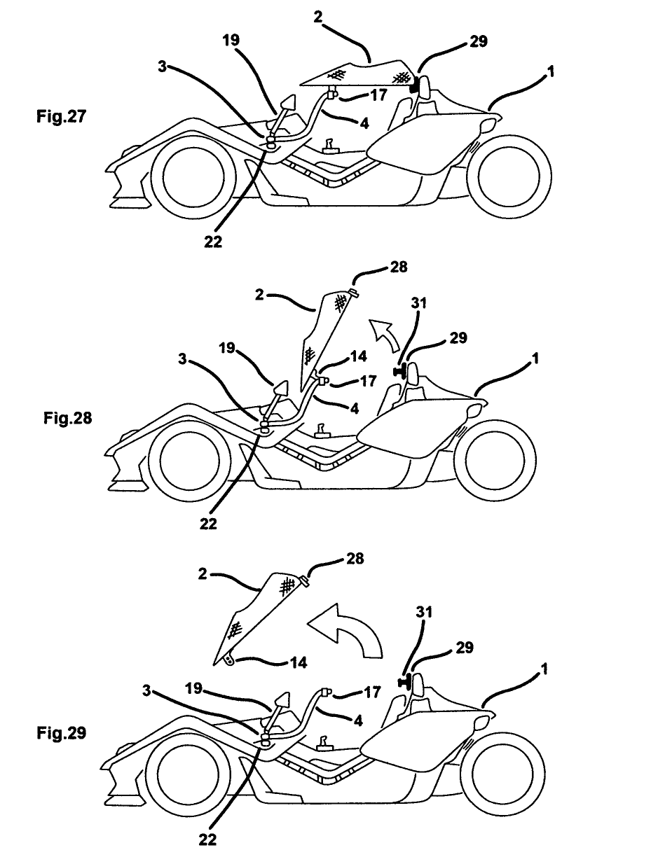

One immediate benefit is the ability to enter and exit vehicle 1 as shown in FIG. 27-28. In FIG. 27 the canopy top with cover 2 is lowered onto vehicle 1 and is secured to the rear roll over bars by means of latch 27, latch frame bracket 28, roll bar mounting bracket 29, and stricker bolt 31. Canopy top cover is also shown secured to the front area of described three-wheeler vehicle an autocycle by means of mounting A-arm 4, front A-arm mounting bracket 3, and A-arm pivot bracket 17.

FIG. 28 illustrates the entry exiting position of canopy top 2 as mounted to vehicle 1. Latch 27 is released allowing rotational movement of canopy top 2 around axis of A-arm pivot bracket 17 when secured to front mounting A-arm 4 by means of A-arm pivot mounting bolt 18 and frame hoop tilt bracket 14. Attachment of canopy top with cover 2 to front mounting A-arm 4 can be accommodated by other methods not shown in drawings. The attachment can be accomplished by A-arm pivot mount bolt 18 or removable thumb screw, or knob.

FIG. 29 shows a side perspective view of three-wheeled vehicle and autocycle 1 with canopy top with cover 2 completely removed from vehicle 1. Illustration present preferred embodiment of invention removed from front mounting A-arm 4 and vehicle 1 by means of the removal of A-arm pivot mount bolt 18. FIG. 29 further demonstrates the unique ability of presented invention to return represented three-wheeled vehicle and autocycle 1 back to a full open aired cabin as delivered from manufacture.

While several embodiments of the present invention have been shown and described in detail, it to be understood that various changes and modifications could be made without departing from the scope of the invention.

1. A quick release removable canopy top system for an open air three wheeled vehicle or autocycle comprising:
a removable canopy frame having a front portion and a rear portion;
front removable upper mounting brackets pivotably attached to the canopy frame;
removable lower front mounting brackets coupled to the front removeable upper mounting brackets, the lower front mounting brackets being removably attached to the vehicle;
a rear latching mechanism configurably attached to the canopy frame;
pivot mounting points disposed between the canopy frame and the front removeable upper mounting brackets wherein the pivot pointing points can be configured to allow the canopy frame to pivot in an upward position; and
a rear mounting bracket removeably attached to the vehicle, the rear mounting bracket capable of partnering with the rear latching mechanism to connect the canopy frame to the vehicle, wherein the rear portion of the canopy frame is in an upward position when detached from the rear mounting bracket.

2. The canopy top system of claim 1 wherein the canopy frame can be covered by various materials including flexible fabric, mesh fabric, semi-rigid cover or a solid ridged cover material.

3. The canopy top system of claim 2 wherein the covering material can be attached to the canopy frame by mechanical snaps, shock cord and toggles, screws, hook and loop fasteners, buckles, straps or zippers.

4. The canopy top system of claim 1 wherein the canopy frame has an adjustable frame height whereby the adjustable frame height can be adjusted up or down depending on an occupant's height wherein the adjustment is made at the front removable upper mounting brackets and the rear mounting bracket.

5. The canopy top system of claim 1 wherein the front upper mounting brackets and the canopy top are attached via a forward pivoting bracket allowing canopy top frame to be raised and tilted forward for entry and exiting of vehicle.

6. The canopy top system of claim 5 wherein the forward pivoting bracket and the canopy top can be removed from the vehicle by threaded knobs, bolts, pull to release pin or pin.

7. The canopy top system of claim 5 wherein the upper mounting brackets can be detached from the lower mounting bracket of by means of bolts, threaded knobs, pull to release pin, or pin.

8. The canopy top system of claim 1 wherein the canopy frame is secured to the rear mounting bracket wherein the rear latching system is used to secure to at least one striker bolt attached to the rear mounting bracket such that the rear mounting bracket is secured to vehicle.

9. The canopy top system of claim 1 wherein the canopy frame is adjustable in height at the rear mounting bracket using a striker bar, a bolt, or a release pin that is movable up or down by means of spaced mounting holes and or elongated holes applied to rear mounting bracket.

10. The canopy top system of claim 4 further comprising an attachment hardware wherein the rear mounting bracket is designed to allow adjustment of the attachment hardware to be moved up or down to accommodate the occupant's height and to adjust the leading edge of frame for optimal position during forward movement.

11. The canopy top system of claim 1 wherein the canopy frame has an adjustable frame height whereby an adjustment can be arranged for an optimal position for and angle of attack of a leading edge of the canopy frame during forward movement of the vehicle.

12. The canopy top system of claim 1 wherein the pivot mounting points comprise a frame tilt bracket, the frame tilt bracket being configurably attached to the front removeable upper mounting brackets.
